(19) United States
(12) Patent Application Publication
(10) Pub. No.: US 2026/0054439 A1
(43) Pub. Date: Feb. 26, 2026

(54) HIGHLY ORIENTED LINEAR LOW DENSITY POLYETHYLENE FILMS WITH OUTSTANDING PROCESSABILITY AND MECHANICAL PROPERTIES

(71) Applicant: ExxonMobil Chemical Patents Inc., Baytown, TX (US)

(72) Inventors: Nino RUOCCO, Houston, TX (US); Wen LI, Houston, TX (US); Xin ZHANG, Shanghai (CN); Kai WANG, Shanghai (CN); Xin Hao CAI, Shanghai (CN)

(21) Appl. No.: 18/702,075

(22) PCT Filed: Oct. 18, 2022
(86) PCT No.: PCT/US2022/078270

§ 371 Date: Apr. 17, 2024

Related U.S. Application Data
(60) Provisional application No. 63/263,061, filed on Oct. 26, 2021.

(51) Int. Cl. B29C 48/00; B29C 48/08; B29K 23/00; B29L 7/00

(52) U.S. Cl. CPC B29C 48/0017; B29C 48/022; B29C 48/08; B29K 2023/08; B29K 2995/0012; B29K 2995/0051; B29K 2995/0077; B29K 2995/0088; B29K 2995/0097; B29L 2007/008

(57) ABSTRACT

Polyethylene compositions that exhibit an excellent balance of flexibility, processability, and mechanical strength. The polyethylene compositions have a surprising balance between BOCD-type profiles and molecular weights that can be used to fabricate highly oriented monolayer blown-MDO films with high stiffness and good puncture.

### CROSS-REFERENCE TO RELATED APPLICATION

This application claims the benefit of U.S. Provisional Application 63/263,061 filed Oct. 26, 2021, entitled “Highly Oriented Linear Low Density Polyethylene Films With Outstanding Processability And Mechanical Properties”, the entirety of which is incorporated by reference herein.

### FIELD

The present disclosure relates to linear low density polyethylene (LLDPE) compositions and highly oriented films made therefrom.

### BACKGROUND

Polyolefin polymer compositions are in high demand for many applications, including various films (such as cast films, shrink films, and blown films), sheets, membranes such as geomembranes, sacks, pipes (e.g., polyethylene of raised temperature (PE-RT) pipes, utility pipes, and gas distribution pipes), roto-molded parts, blow-molded flexible bottles or other containers, and various other blow molded/extruded articles such as bottles, drums, jars, and other containers. These applications have been commonly made from polyethylenes because polyethylene compositions offer an attractive balance of mechanical strength, stress crack resistance, and flexibility. Low density polyethylenes (LDPEs) are commonly more pliable but weaker and high-density polyethylenes (HDPEs) are commonly stronger and stiffer.

In the world of film making, polyethylene films are of interest because polyethylene is more readily recycled. However, polyethylene tends to have a higher crystallinity than polypropylene, making it more difficult to down gauge and maintain a suitable balance of stiffness and toughness characteristics. High performance polyolefins, such as low density polyethylene (LDPE), have been able to lower manufacturing costs sufficient to justify commercial use in food packaging as well as trash bags, including heavy duty garbage bags, leaf bags, and trash can liners. Low density polyethylene allows for the production of bags with remarkably thin gauge and flexibility while maintaining high strength characteristics such as puncture and tensile strength.

More recently, linear low density polyethylene (LLDPE) has been used in place of conventional highly branched LDPE in many film applications, including bags. Linear low density polyethylenes (LDPE) is a substantially linear polymer, with significant numbers of short branches, commonly made by copolymerization of ethylene with longer-chain olefins, typically alpha-olefin comonomer, particularly when made in a low-pressure polymerization process such as, for example, solution, slurry, and/or gas phase polymerization processes. Such polyethylene compositions may therefore be referred to as ethylene alpha-olefin copolymers.

LLDPE is widely recognized as being tougher and stronger than LDPE, thus contributing to reduced bag failures, including punctures and splitting under stress. In particular, LLDPEs made with metallocene or single site catalysts, and LLDPEs containing hexene and/or octene comonomers have been used to provide improved toughness. However, LLDPE's are difficult to process. Much effort has been placed in understanding how the comonomer is distributed along the polymer carbon chain or simply polymer chain of a polyolefin polymer such as a polyethylene composition. For example, the composition distribution of an ethylene alpha-olefin copolymer refers to the distribution of comonomer (short chain branches) among the molecules that comprise the polyethylene polymer. When the amount of short chain branches varies among the polymer carbon chains of different length, the polymer or resin is said to have a Broad Composition Distribution (BCD). For example, for an ethylene-hexene copolymer, hexene distribution varies from low to high even among polymer chains of similar length (e.g., the polydispersity index or PDI among those chains is narrow). When the amount of comonomer per about 1000 carbons is similar among the polyethylene molecules of different polymer chain lengths or molecular weights, the composition distribution is said to be “narrow” or have a Narrow Composition Distribution (NCD).

The composition distribution is known to influence the properties of copolymers, for example, extractables content, environmental stress crack resistance, heat sealing, dart drop impact resistance, and tear resistance or strength. The composition distribution of a polyolefin may be readily measured by methods known in the art, for example, Temperature Raising Elution Fractionation (TREF) or Crystallization Analysis Fractionation (CRYSTAF). See, for example, U.S. Pat. No. 8,378,043, Col. 3 and Col. 4.

Polymers made with Zeigler Natta catalysts are considered to be “conventional” in which the composition distribution is broad but the high molecular weight fractions are higher density (i.e., less comonomer) than the lower molecular weight fraction (high comonomer).

In contrast, metallocene catalysts typically produce a polyolefin polymer composition with an NCD. A metallocene catalyst is generally a metal complex of a transitional metal, typically, a Group 4 metal, and one or more cyclopentadienyl (Cp) ligands or rings. As stated above, NCD generally refers to the comonomer being evenly distributed or not vary much along the polymer chain.

More recently, a third distribution has been described for a polyolefin polymer composition having a Broad Orthogonal Composition Distribution (BOCD) in which the s comonomer is incorporated predominantly in the high molecular weight chains. A substituted hafnocene catalyst has been noted to produce this type of distribution. See, for example, U.S. Pat. Nos. 6,242,545, 6,248,845, 6,528,597, 6,936,675, 6,956,088, 7,172,816, 7,179,876, 7,381,783, 8,247,065, 8,378,043, 8,476,392; U.S. Patent Application Publication Nos. 2015/0291748 and 2020/0071437. This distribution has been noted for its improved physical properties, for example, ease in fabrication of end-use articles as well as stiffness and toughness in multiple applications such as films that can be measured by dart drop impact resistance and tear resistance or strength.

U.S. Pat. No. 9,290,593 ('593 patent) teaches that the term “BOCD” is a novel terminology that is currently developed and relates to a polymer structure. The term “BOCD structure” means a structure in which the content of the comonomer such as alpha olefins is mainly high at a high molecular weight main chain, that is, a structure in which the content of a short chain branching (SCB) is increased as moving toward the high molecular weight. The '593 patent also teaches a BOCD Index. More recently, another U.S. Pat. No. 10,344,102 ('102 patent) teaches a similar value, the Comonomer Incorporation (CI) index. Both aim to capture a comparison of SCB content in high-molecular weight chains vs. SCB content in low molecular-weight chains of the polymer composition, generally as (#SCB at high MW-#SCB at low molecular weight)/(#SCB at low molecular weight). The patents differ somewhat in their description of how the “high molecular weight” and “low molecular weight” points are identified and calculated, but both base the identification on GPC-4D plots of SCB content vs. molecular weight (see FIG. 1 of the '593 patent and FIG. 4 of the '102 patent). The '593 patent asserts the BOCD Index of its polymer compositions may be in the range of 1 to 5, preferably 2 to 4, more preferably 2 to 3.5; similarly, the '102 patent asserts the CI index of its polymer compositions range from 0.5 to 5.

BOCD behavior in a polymer composition has been associated with a good balance of mechanical and optical properties and has been an important goal in the development of new polymer products. BOCD has been targeted and improved in various linear PE compositions, see for instance US Patent Publication No. 2020/0071437; but there remains a need for polyethylene compositions having BOCD, and furthermore, the challenge also remains to achieve higher degrees of BOCD than has been achieved previously.

U.S. Pat. No. 9,068,033 discloses ethylene hexene copolymers having, inter alia, a g′ᵥᵢₛ of less than 0.8, a melt index, 12, of 0.25 to 1.5 g/10 min, that are converted into films.

Some other references of potential interest in this regard include US patent numbers: U.S. Pat. Nos. 5,955,625; 6,168,826; 6,225,426; 9,266,977; EP 2935367; US patent application publication numbers: US 2008/0233375; US 2016/0031191; US 2015/0258756; US 2009/0286024; US 2018/0237558; US 2018/0237559; US 2018/0237554; US 2018/0319907; US 2018/0023788; WIPO patent application publication numbers: WO 2017/127808; WO 2015/154253; WO 2015/138096; WO 1997/022470; Japanese Pat. App. Pub. No. 2016/147430; Kim, W. N. et al. (1994) “Morphology and Mechanical Properties of Biaxially Oriented Films of Polypropylene and HDPE Blends,” Appl. Polym. Sci., v. 54(11), pp. 1741-1750; Ratta, V. et al. (2001) “Structure-Property-Processing Investigations of the Tenter-Frame Process for Making Biaxially Oriented HDPE Film. I. Base Sheet and Draw Along the MD” Polymer, v. 42(21), pp. 9059-9071; Ajji, A. et al. (2004) “Biaxial Stretching and Structure of Various LLDPE Resins” Polym. Eng. Sci., v. 44(2), pp. 252-260; Ajji, A. et al. (2006) “Biaxial Orientation in LLDPE Films: Comparison of Infrared Spectroscopy, X-ray Pole Figures, and Birefringence Techniques,” Polym. Eng. Sci., v. 46(9), pp. 1182-1189; Uehara, H et al. (2004) “Stretchability and Properties ofLLDPE Blends for Biaxially Oriented Film,” Intern. Polymer Processing, v. 19(2), pg. 163; Bobovitch, A. L. et al. (2006) “Mechanical Properties Stress-Relaxation, and Orientation of Double Bubble Biaxially Oriented Polyethylene Films,” J. Appl. Poly. Sci., v. 100(5), pp. 3545-3553; Sun, T. et al. (2001) Macromolecules, v. 34(19), pp. 6812-6820; Stadelhofer, J. et al. (1975) “Darstellung und Eigenschaften von Alkylmetallcyclo-Pentadienderivaten des Aluminiums, Galliums und Indiums,” Jrnl. Organometallic Chem., v. 84, pp. C1-C4 and Chen, Q. et al. (2019) “Structure Evolution of Polyethylene in Sequential Biaxial Stretching along the First Tensile Direction,” Ind. Eng. Chem. Res., v. 58, pp. 12419-12430; Anon., Novel polymers offering high toughness after orientation in the machine direction through the MDO process, IPCOM000267014D (IP.com, Sep. 16, 2021); Anon., Oriented polyethylene films with high stiffness, high MD tear and high dart impact forces, IPCOM000265577D (IP.com, Apr. 27, 2021); Anon., Novel polymer offering extreme flex-crack resistance in hot-filled multi-walled Bag-in-Box application, IPCOM000267154D (IP.com, Sep. 29, 2021).

Other relevant references in this regard include: U. S. Patent Application Publication Nos. 2009/0156764, 2019/0119417 and 2020/0071437; as well as U.S. Pat. Nos. 7,119,153, 7,547,754, 7,572,875, 7,625,982, 8,383,754, 8,691,715, 8,722,567, 8,846,841, 8,940,842, 9,006,367, 9,096,745, 9,115,229, 9,181,369, 9,181,370, 9,217,049, 9,334,350, 9,447,265, 10,040,883; 10,344,102. See also WO2008/136621; WO 2015/123164; WO2019/027598; WO2019/083609; EP 2076565B1; EP 1732958B1; EP 1674504A1.

### SUMMARY

Polyethylene compositions and especially linear low density polyethylene (LLDPE) compositions are provided herein. The polyethylene compositions can include about 80 wt % to about 99 wt % ethylene-derived content, and about 1.0 wt % to about 20 wt % units derived from one or more C₃ to C₄₀ α-olefin comonomers, based on a total weight of the polyethylene composition. The resulting polyethylene composition can have a density of 0.916 g/cm³ to 0.940 g/cm³; a melt index (I_{2.16}) of 0.1 g/10 min to 5 g/10 min; a melt index ratio (I_{2.16}/I_{21.6}) of to 50; a weight average molecular weight, Mw (LS) of 90,000 g/mol or above; a molecular weight distribution (Mw/Mn) ratio (LS) of 5.5 or above; a ratio of z-average molecular weight to weight-average molecular weight (Mz/Mw) of 2 to 5; a ratio of wt % comonomer at Mz (LS) to wt % comonomer at Mw (LS) of 1 to 5; a ratio of wt % comonomer at Mn (LS) to wt % comonomer at Mw (LS) of 0.1 to 0.9; and a ratio of wt % comonomer at Mz (LS) to wt % comonomer at Mn (LS) of 2 to 10.

The polyethylene compositions have a high degree of broad orthogonal composition distribution (BOCD), meaning that a substantially higher degree of short chain branching is present on longer molecular-weight polymer chains than on shorter molecular-weight polymer chains within the polyethylene composition.

The polyethylene compositions provided herein exhibit an excellent balance of flexibility, processability, and mechanical strength. The polyethylene compositions have a surprising balance between BOCD-type profiles and molecular weights that can be used to fabricate highly oriented monolayer blown-MDO films with high stiffness and good puncture.

Films made from the polyethylene compositions provided herein, surprisingly and unexpectedly, show an excellent balance of processability (high stretchability) and mechanical properties (high stiffness and puncture resistance). At orientations above 5×, films made from the polyethylene compositions show high stiffness in terms of 1% secant modulus and tensile at break along the machine direction (MD) as well as peak force (needle puncture test) values. Films made from the polyethylene compositions provide excellent opportunities for downgauging when stretched at high orientations. These films can maintain competitive stiffness and toughness when downgauged.

### BRIEF DESCRIPTION OF THE DRAWINGS

FIG. 1 shows the GPC4D Data of resins C-1, C-2 and I-1.

FIG. 2 shows the 1% secant modulus vs. MDO of resins C-1, C-2 and I-1.

FIG. 3 shows the peak force (puncture) vs. MDO of resins C-1, C-2 and I-1.

### DETAILED DESCRIPTION

The present disclosure relates to polyolefin compositions, their methods of manufacture, and articles including and/or made from the polyolefin compositions. In a particular focus, the polyolefin compositions may be polyethylene compositions. The present disclosure also relates to oriented polyethylene films comprising polyethylene compositions with properties that improve processability while providing a good balance between stiffness while providing high toughness (or impact resistance).

Polyethylene compositions in accordance with the present disclosure are preferably copolymers of majority ethylene (e.g., 80, 85, 90, 95, 98, 99 wt % or more ethylene-derived units, preferably 98 wt % or more) and one or more C₃ to C₄₀ comonomers (e.g., 1-butene, 1-hexene, 1-octene). Preferably, such polyethylene compositions are linear low density polyethylene (LLDPE) compositions (e.g., having density within the range from 0.900 to 0.940 g/cm³ in accordance with various embodiments) that exhibit a high degree of broad orthogonal composition distribution (BOCD); that is, with a high degree of short chain branching (SCB)—also referred to as comonomer incorporation—on longer-molecular weight chains within the polyethylene composition, as compared to SCB in the lower-molecular weight chains of the polyethylene composition. The polyethylene compositions also are preferably substantially linear, which may be indicated through, e.g., the similarity of their Mz/Mw ratios (z-average molecular weight to weight-average molecular weight ratios) to their melt index ratios (MIR, the ratio of high load melt index (HLMI, 21.6 kg—also referred to as I_{21.6}) to melt index (MI, 2.16 kg—also referred to as I₂ or I_{2.16})).

### Definitions

For the purposes of the present disclosure, various terms are defined as follows.

The term “polyethylene” refers to a polymer having at least 50 wt % ethylene-derived units, such as at least 70 wt % ethylene-derived units, such as at least 80 wt % ethylene-derived units, such as at least 90 wt % ethylene-derived units, or at least 95 wt % ethylene-derived units, or 100 wt % ethylene-derived units. The polyethylene can thus be a homopolymer or a copolymer, including a terpolymer, having one or more other monomeric units. A polyethylene described herein can, for example, include at least one or more other olefin(s) and/or comonomer(s).

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 50 wt % to 55 wt %, it is understood that the mer unit in the copolymer is derived from ethylene in the polymerization reaction and said derived units are present at 50 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically.

The term “alpha-olefin” or “α-olefin” refers to an olefin having a terminal carbon-to-carbon double bond in the structure thereof R¹R²C═CH₂, where R¹ and R² can be independently hydrogen or any hydrocarbyl group; such as R¹ is hydrogen and R² is an alkyl group. A “linear alpha-olefin” is an alpha-olefin wherein R¹ is hydrogen and R² is hydrogen or a linear alkyl group. For the purposes of the present disclosure, ethylene shall be considered an α-olefin.

When a polymer or copolymer is referred to herein as comprising an alpha-olefin (or α-olefin), including, but not limited to ethylene, 1-butene, and 1-hexene, the olefin present in such polymer or copolymer is the polymerized form of the olefin. For example, when a polymer is said to have an “ethylene content” or “ethylene monomer content” of 80 to 99.9 wt %, or to comprise “ethylene-derived units” at 80 to 99.9 wt %, it is understood that the mer unit in the copolymer is derived from ethylene in the polymerization reaction and said derived units are present at 80 to 99.9 wt %, based upon the weight of ethylene content plus comonomer content.

As used herein, and unless otherwise specified, the term “Cₙ” means hydrocarbon(s) having n carbon atom(s) per molecule, wherein n is a positive integer.

The terms “substituent,” “radical,” “group,” and “moiety” may be used interchangeably.

A “catalyst composition” or “catalyst system” is the combination of at least two catalyst compounds, a support material, an optional activator, and an optional co-activator. For the purposes of this invention and the claims thereto, when catalyst systems or compositions are described as comprising neutral stable forms of the components, it is well understood by one of ordinary skill in the art, that the ionic form of the component is the form that reacts with the monomers to produce polymers. When it is used to describe such after activation, it means the support, the activated complex, and the activator or other charge-balancing moiety. The transition metal compound may be neutral as in a precatalyst, or a charged species with a counter ion as in an activated catalyst system.

The terms “cocatalyst” and “activator” are used herein interchangeably and are defined to be any compound which can activate any one of the catalyst compounds herein by converting the neutral catalyst compound to a catalytically active catalyst compound cation.

As used herein, the terms “machine direction” and “MD” refer to the stretch direction in the plane of the film.

As used herein, the terms “transverse direction” and “TD” refer to the perpendicular direction in the plane of the film relative to the MD.

As used herein, the term “extruding” and grammatical variations thereof refer to processes that includes forming a polymer and/or polymer blend into a melt, such as by heating and/or sheer forces, and then forcing the melt out of a die in a form or shape such as in a film. Most any type of apparatus will be appropriate to effect extrusion such as a single or twin-screw extruder, or other melt-blending device as is known in the art and that can be fitted with a suitable die.

### Polyethylene Compositions

In various embodiments, the present disclosure describes compositions of, and/or methods for making, polyethylene compositions including polyethylene homopolymers, and/or copolymers of ethylene and one, two, three, four or more C₃ to C₄₀ olefin comonomers, for example, C₃ to C₂₀ α-olefin comonomers.

For example, the polyethylene compositions may include copolymers of ethylene and one, two or three or more different C₂ to C₄₀ olefins. In particular embodiments, the polyethylene compositions comprise a majority of units derived from polyethylene, and units derived from one or more C₃ to C₄₀ comonomers, preferably C₃ to C₂₀ α-olefin comonomers (e.g., propylene, 1-butene, 1-hexene, 1-octene, 1-decene, 1-dodecene, preferably propylene, 1-butene, 1-hexene, 1-octene, or a mixture thereof; most preferably 1-butene and/or 1-hexene).

The polyethylene composition may comprise the ethylene-derived units in an amount of at least 80 wt %, or 85 wt %, preferably at least 90, 93, 94, 95, or 96 wt % (for instance, in a range from a low of 80, 85, 90, 91, 92, 93, 94, 95, 96, or 97 wt %, to a high of 94, 95, 95.5, 96, 96.5, 97, 97.5, or 98 wt %, with ranges from any foregoing low end to any foregoing high end contemplated, provided the high is greater than the low). For instance, the polyethylene composition may comprise 94 or 95 wt % to 97 or 98 wt % ethylene-derived units. Comonomer units (e.g., C₂ to C₂₀ α-olefin-derived units, such as units derived from butene, hexene, and/or octene) may be present in the polyethylene composition within the range from a low of 4, 4.5, 5, or 6 wt %, to a high of 10, 12, 14 or 15 wt %, with ranges from any foregoing low ends to any foregoing high ends contemplated (provided the high is greater than the low end). For instance, the polyethylene composition may comprise 4, 4.5, or 5 wt % to 12 or 14 wt % comonomer units.

Several suitable comonomers are noted above, although in various embodiments, other α-olefin comonomers are contemplated. For example, the α-olefin comonomer can be linear or branched, and two or more comonomers can be used, if desired. Examples of suitable comonomers include linear C₃-C₂₀ α-olefins (such as butene, hexene, octane as already noted), and α-olefins having one or more C₁-C₃ alkyl branches, or an aryl group. Specific examples include propylene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be appreciated that the list of comonomers above is merely exemplary, and is not intended to be limiting. In some embodiments, comonomers include propylene, 1-butene, 1-pentene, 4-methyl-1-pentene, 1-hexene, 1-octene and styrene.

### Polyethylene Composition—Molecular Characteristics

A polyethylene composition according to various embodiments can have a density of 0.900 to 0.940 g/cm³, such as 0.910 to 0.937 g/cm³, or 0.916 to 0.940 g/cm³, although in some embodiments preferred density is above 0.921 g/cm³, such as within the range from 0.922 to 0.940 g/cm³, or from a low of any one of 0.922, or 0.923 g/cm³ to a high of any one of 0.930, 0.933, or 0.935 g/cm³, with ranges of various embodiments including any combination of any upper or lower value disclosed herein. Density herein is measured by displacement method according to ASTM D1505.

In various embodiments, the polyethylene composition has one or more, two or more, or, preferably, all of the following molecular weights (determined by GPC using the LS detector):
weight-average molecular weight (Mw) within the range generally from 50,000 to 200,000 g/mol, but preferably from 50,000 to 110,000 g/mol, such as from a low end of any one of 50,000 g/mol; 55,000 g/mol; 60,000 g/mol; 65,000 g/mol; 70,000 g/mol; 75,000 g/mol; 80,000 g/mol; 85,000 g/mol; and 90,000 g/mol, to a high end of any one of 108,000 g/mol; 110,000 g/mol; or 112,000 g/mol, with ranges from any one of the foregoing low ends to any one of the high ends contemplated in various embodiments. In yet other embodiments, however, a higher Mw may be utilized (e.g., from any of the foregoing low ends to a high end of any one of 115,000; 125,000; 135,000; 150,000; or 200,000 g/mol);
number-average molecular weight (Mn) generally within the range from 7,000 to 40,000 g/mol, such as from a low end of any one of 8,000 g/mol; 9,000 g/mol; 10,000 g/mol; 11,000 g/mol; 12,000 g/mol, and 13,000 g/mol to ahigh end of any one of 15,000 g/mol; 20,000 g/mol; 25,000 g/mol; 28,000 g/mol; 29,000 g/mol; 30,000 g/mol, 35,000 g/mol; 38,000 g/mol, and 40,000 g/mol. Ranges from any one of the foregoing low ends to any one of the high ends are contemplated in various embodiments (for instance, Mn may be within the range from 10,000 g/mol to 30,000 g/mol, such as 12,000 or 13,000 g/mol to 20,000 or 25,000 g/mol);
Z-average molecular weight (Mz) generally within the range from 150,000 to 400,000 g/mol, such as from a low end of any one of 175,000 g/mol; 200,000 g/mol; 225,000 g/mol; and 250,000 g/mol to a high end of any one of 290,000 g/mol; 300,000 g/mol; 325,000 g/mol; 350,000 g/mol; 375,000 g/mol; and 400,000 g/mol. Ranges from any one of the foregoing low ends to any one of the high ends are contemplated in various embodiments.

Furthermore, polyethylene compositions in accordance with various embodiments may have Mw/Mn value (sometimes also referred to as polydispersity index, PDI) within the range from a low of 3.0, 3.5, 4.0, 4.5, 4.7, 5.0, 5.1, 5.2, or 5.5 to a high of 5.5, 5.7, 6.0, 6.1, 6.2, 6.3, 6.4, 6.5, 7.0, 7.5, 7.8, 7.9, 8.0, 8.5, 9.5, or 10 (with ranges from any low end to any high end contemplated, such as Mw/Mn from 4.0 to 7.9 or 8.0, such as from 5.5 to 7.3). The Mz/Mw ratio of the polyethylene compositions of various embodiments are within the range from 2.0 to 5.0. The Mz/Mw ratio can also range from a low of 2.0, 2.2, 2.4, or 2.5 to a high of 3.0, 3.5 4.0, 4.5 or 5.0 (with ranges from any low end to any high end contemplated, such as Mz/Mw from 2.2 to 5, such as 2.4 to 4.5). Alternatively, polyethylene compositions of various embodiments may be characterized as having Mz/Mw less than 5, such as less than 4.5, less than 4, or less than 3.5, or less than 3.0. The Mz/Mn ratio of the polyethylene compositions of various embodiments are within the range from 10 to 50. The Mz/Mn ratio can also range from a low of 10, 15, 17, or 19 to a high of 20, 22, 25, 30, 35, or 40 (with ranges from any low end to any high end contemplated, such as Mz/Mn from 15 to 22 or 25).

Furthermore, polyethylene compositions in accordance with various embodiments may have a melt temperature of 130° C. or less. The melt temperature may also be less than 128° C., 125° C., or 123° C. The melt temperature may also range from a low of about 100° C., 105° C., or 110° C. to a high of about 120° C., 125° C., or 130° C.

Furthermore, polyethylene compositions in accordance with various embodiments may have a ratio of wt % comonomer at Mz (LS) to wt % comonomer at Mw (LS) of 1 to 5. Polyethylene compositions in accordance with various embodiments may also have a ratio of wt % comonomer at Mn (LS) to wt % comonomer at Mw (LS) of 0.1 to 0.9. Polyethylene compositions in accordance with various embodiments may also have a ratio of wt % comonomer at Mz (LS) to wt % comonomer at Mn (LS) of 2 to 10.

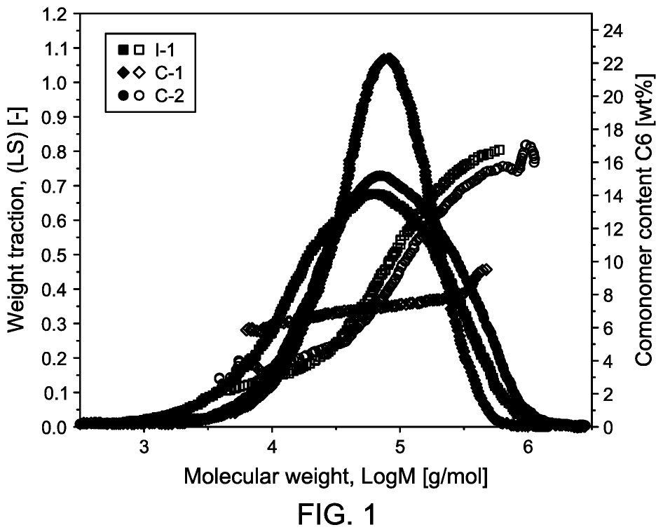

Furthermore the polyethylene compositions of various embodiments described herein exhibit unimodal distribution with respect to molecular weight of polymer chains, meaning that there is a single distinguishable peak in a molecular weight distribution curve of the composition (as determined using gel permeation chromatography (GPC) or other recognized analytical technique, noting that if there is any conflict between or among analytical techniques, a molecular weight distribution determined by GPC, as described below, shall control). Examples of “unimodal” molecular weight distribution can be seen in U.S. Pat. No. 8,691,715, FIG. 6 of such patent, which is incorporated herein by reference. This is in contrast with a “multimodal” molecular weight distribution, which means that there are at least two distinguishable peaks in a molecular weight distribution curve (again, as determined by GPC or any other recognized analytical technique, with GPC controlling in the event of any conflict). For example, if there are two distinguishable peaks in the molecular weight distribution curve such composition may be referred to as bimodal composition. For example, in the '715 patent, FIGS. 1-5 of that patent illustrate representative bimodal molecular weight distribution curves. In these figures, there is a valley between the peaks, and the peaks can be separated or deconvoluted.

### Composition Distribution

As noted, polyethylene compositions of the present disclosure exhibit BOCD characteristics. Several methods can illustrate the high degree of preferential comonomer incorporation along the high molecular-weight chains of the polyethylene composition. For example, the polyethylene composition may have the same BOCD characteristics for embodiments described in (and determined in the same manner as detailed in) Paragraphs [0051]-[0055] and [0160] of WO2019/083609, which description is incorporated by reference herein.

### Other Rheological Properties

In various embodiments, the polyethylene compositions have a melt index, (MI, also referred to as I₂ or I_{2.16} in recognition of the 2.16 kg loading used in the ASTM D1238 test procedure) within the range from 0.1 g/10 min to 5 g/10 min, such as from a low of any one of 0.1, 0.2, 0.3, 0.4 g/10 min, to a high of 0.5, 0.55, 0.60, 0.65, 0.70, 0.75, 1.0, 1.2, 1.5, 1.7, 2.0, 3.0, 4.0, 5.0, or 10.0 g/10 min, with ranges from any of the foregoing low ends to any of the foregoing high ends contemplated herein) (e.g., 0.1 to 1.0 g/10 min, such as 0.3 to 0.7 g/10 min, or 0.4 to 0.6 g/10 min).

Moreover, polyethylene compositions of various embodiments can have a high load melt index (HLMI) (also referred to as I₂₁ or I_{21.6} in recognition of the 21.6 kg loading used in the ASTM D1238 test procedure) of at least 25, but more preferably above 40 g/10 min, such as within the range from a low of 41, 43, 45, or 50 g/10 min to a high of 55, 60, 65, 70, 75, or 80 g/10 min; with ranges from any of the foregoing lows to any of the foregoing highs contemplated herein (e.g., 41 to 70 g/10 min, such as 50 to 60 g/10 min).

Polyethylene compositions according to various embodiments may have a melt index ratio (MIR, defined as I_{21.6}/I_{2.16}) within the range from a low of any one of 10, 15, 20, or to a high of any one of 35, 40, 45, or 50, with ranges from any of the foregoing lows to any of the foregoing highs contemplated herein (e.g., 15 to 45, such as 20 to 45, or 15 to 40). Alternatively, MIR may be less than or equal to 50, 45, 40, or 35.

### Methods of Making Polyethylene Compositions

In embodiments herein, the invention relates to polymerization processes where monomer (such as ethylene), and optionally comonomer (e.g., any of the above-described comonomers), are contacted with a catalyst system comprising at least one activator, at least one support and at least one catalyst, such as a metallocene compound. Catalyst systems are described in more detail below. The support, catalyst compound, and activator may be combined in any order, and are combined typically prior to contacting with the monomers.

Polymerization processes according to the present disclosure can be carried out in any manner known in the art. Any suspension, slurry, high pressure tubular or autoclave process, or gas phase polymerization process known in the art can be used under polymerizable conditions. Such processes can be run in a batch, semi-batch, or continuous mode. Heterogeneous polymerization processes (such as gas phase and slurry phase processes) are useful. A heterogeneous process is defined to be a process where the catalyst system is not soluble in the reaction media. Alternatively, in other embodiments, the polymerization process is not homogeneous.

In various embodiments, polymerization processes as described generally in paragraphs [0104]-[0114] of WIPO Publication WO2019/083609, which description is incorporated by reference herein, may be suitable (e.g., gas-phase or slurry-phase processes as described therein).

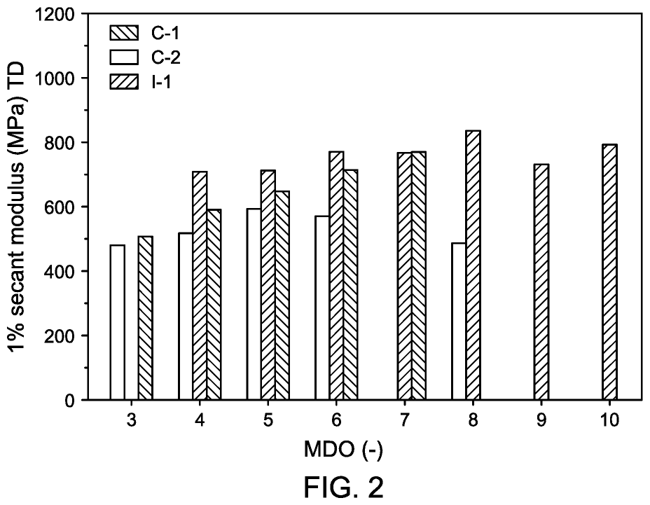

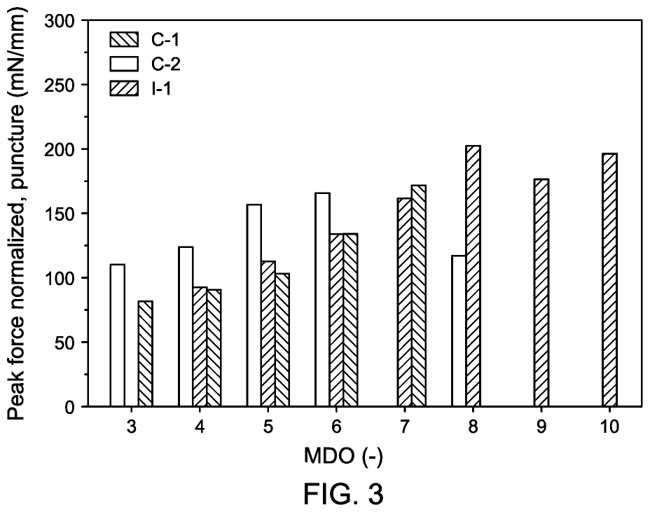

In particular embodiments, the polymerization is performed in the gas phase, in particular in a gas-phase fluidized bed reactor system in accordance with the general description of Paragraphs [0172]-[0178] and FIG. 2 of US Patent Publication US2020/0071437, which description and figure are incorporated by reference herein. Furthermore, a catalyst system comprising two catalyst compositions (as described below) may be used, and delivered to the fluidized bed reactor as a catalyst component solution and catalyst component slurry combined and delivered as described in the systems and processes in US2020/0071437, Paragraphs [0145]-[0171] and FIGS. 2 and 3, which description is also incorporated herein by reference.

In particular embodiments herein, the polymerization to obtain the polyethylene composition takes place in a single reactor, or in multiple parallel reactors with post-reactor blending, as opposed to taking place in multiple series reactors. However, it is also contemplated that the polyethylene composition could, in other embodiments, be formed in multiple (two or more) series reactors.

### Catalyst Systems and Activators

As noted, suitable polymerization processes employ a polymerization catalyst system, and in particular a polymerization catalyst system comprising at least one activator, at least one support and at least one catalyst composition. The catalyst composition is preferably a single-site catalyst, such as a metallocene catalyst.

Any suitable polymerization catalyst may be used to obtain the polyethylene compositions as described herein (e.g., Ziegler-Natta, single-site such as metallocene, etc.), but preferred catalyst systems employ a catalyst system comprising a mix of two metallocene catalysts: a bis-cyclopentadienyl hafnocene and a zirconocene, such as an indenyl-cyclopentadienyl zirconocene, such as those described in US2020/0071437 and/or in WO2019/083609.

And, more particularly, in catalyst systems comprising a mix of a bis-cyclopentadienyl hafnocene and a zirconocene, the bis-cyclopentadienyl hafnocene may be in accordance with one or more of the following metallocene catalyst compositions according to formulas (A1) and/or (A2) as described in US2020/0071437; and the zirconocene may be in accordance with one or more of the catalyst compositions of formula (B) as described in US2020/0071437. Further, the catalyst system may be delivered to the polymerization reactor (e.g., gas phase fluidized bed polymerization reactor; slurry loop polymerization reactor, or other suitable reactor) in a catalyst trim methodology as described in paragraphs [0134]-[0139] of US2020/0071437. Further, any of the activators and/or supports and other catalyst additives as described in US2020/0071437 may be employed in connection with the catalyst system.

### Films and Methods

The polyethylene prepared by the process described herein are preferably formed into films, particularly oriented films, such as machine direction oriented (MDO) films. Preferably, films of the present disclosure contain the polyethylene described herein in an amount of at least 90 wt % (or 90 wt % to 100 wt %, or 90 wt % to 99.9 wt %, or 95 wt % to 99 wt %). Advantageously, the polyethylene described herein does not need to be mixed with another polymer to achieve good processability and film properties.

In addition to the polyethylene, the films may include one or more additives. Examples of additives include, but are not limited to, stabilization agents (e.g., antioxidants or other heat or light stabilizers), anti-static agents, crosslink agents or co-agents, crosslink promoters, release agents, adhesion promoters, plasticizers, anti-agglomeration agents (e.g., oleamide, stearamide, erucamide or other derivatives with the same activity), and fillers.

Nonlimiting examples of antioxidants include, but are not limited to, IRGANOX® 1076 (a high molecular weight phenolic antioxidant, available from BASF), IRGAFOS® 168 (tris(2,4-di-tert-butylphenyl) phosphite, available from BASF), and tris(nonylphenyl)phosphite. A nonlimiting example of a processing aid is DYNAMAR® FX-5920 (a free-flowing fluropolymer based processing additive, available from 3M).

When present, the amount of the additives cumulatively can range from 0.01 wt % to 1 wt % (or 0.01 wt % to 0.1 wt %, or 0.1 wt % to 1 wt %).

Methods of producing machine direction oriented (MDO) polyethylene films can include: producing a polymer melt comprising a polyethylene described herein, extruding a film from the polymer melt; and stretching the film at a temperature below the melting temperature of the polyethylene. Stretching can be achieved by threading the film through a series of rollers where the temperature and speed of the individual rollers are controlled to achieve a desired film thickness and the stretch ratio. Typically, this series of rollers are called MDO rollers or part of the MDO stage of the film production. Examples of MDO may include, but are not limited to, pre-heat rollers, various stretching stages with or without annealing rollers between stages, one or more conditioning and annealing rollers, and one or more chill rollers. Stretching of the film in the MDO stage is accomplished by inducing a speed differential between two or more adjacent rollers.

The stretch ratio can be used to describe the degree of stretching of the film. The stretch ratio is the speed of the fast roller divided by the speed of the slow roller. For example, stretching a film using an apparatus where the slow roller speed is 1 m/min and fast roller speed is 7 m/min means the stretch ratio was 7 (also referred to herein as 7 times or 7×). The physical amount of stretching of the film is close to but not exactly the stretch ratio because relaxation of the film can occur after stretching, although typically only to a marginal extent.

Greater stretch ratios result in thinner films with greater orientation in the MD. The stretch ratio when stretching the polyethylene films described herein can be 1× to 10× (or 3× to 10×, or 5× to 10×, or 7× to 9×). One skilled in the art without undue experimentation can determine suitable temperatures and roller speeds for each roller in a given MDO stage of film production for producing the desired stretch ratios.

The MDO polyethylene films described herein can have a gauge thickness of 5 mils to 30 mils (or 15 mils or less, or 10 mils or less, or 8 mils or less, or 7 mils or less, or 5 mils to 10 mils, or 5 mils to 15 mils, or 10 mils to 30 mils).

The MDO polyethylene films described herein can have any one, two, three or more of the following properties:
(I) tan(δ) at ω=0.05 rad/s of 10 to 80 (alternatively 10 to 75; 15 to 65; or 20 to 55);
(II) Complex viscosity, η* at ω=0.05 rad/s (Pa·s) of 2,000 to 20,000 (alternatively 3,000 to 18,000; 5,000 to 17,000; 6,000 to 15,000; or 7,500 to 12,500);
(III) Degree of Shear Thinning (DST) of 0.4 to 0.9 (alternatively 0.45 to 0.85; 0.50 to 0.75; or 0.55 to 0.90);
(IV) 1% secant in the transverse direction (TD) of 400 MPa to 1,000 MPa (alternately 400 MPa to 900 MPa; 500 MPa to 850 MPa; or 525 MPa to 975 MPa).
(V) 1% secant in the transverse direction (MD) of 500 MPa to 1,500 MPa (alternately 500 MPa to 1,500 MPa; 600 MPa to 1,400 MPa; 700 MPa to 1,200 MPa; or 650 MPa to 1,400 MPa).
(VI) Tensile at break (MPa) MD of 100 to 300 (alternatively 120 to 290; 130 to 275; 150 to 260; or 150 to 300);
(VII) Tensile at break (MPa) TD of 20 to 50 (alternatively 20 to 45; 25 to 40; or 25 to 50); and
(VIII) Peak force normalized, puncture (mN/mm) of 100 to 300 (alternatively 120 to 290; 130 to 275; 150 to 260; or 150 to 300).

Because the films described herein are stretched only in the machine direction, the physical properties in the transverse direction may be comparable to other MDO polyethylene films produced with polyethylenes not described herein.

### End Uses

The MDO polyethylene films described herein may be used as monolayer films or as one or more layers of a multilayer film. Examples of other layers include, but are not limited to, unstretched polymer films, other MDO polymer films, and biaxially-oriented polymer films of polymers like polyethylene, polypropylene, polyethylene terephthalate, polystyrene, polyamide, and the like.

The MDO polyethylene films described herein (alone or as part of a multilayer film) are useful end use applications that include, but are not limited to, film-based products, shrink film, cling film, stretch film, sealing films, snack packaging, heavy-duty bags, grocery sacks, baked and frozen food packaging, diaper backsheets, housewrap, medical packaging (e.g., medical films and intravenous (IV) bags), industrial liners, membranes, and the like.

In one embodiment, multilayer films or multiple-layer films may be formed by methods well known in the art. The total thickness of multilayer films may vary based upon the application desired. A total film thickness of about 5-100 μm, more typically about 10-50 μm, is suitable for most applications. Those skilled in the art will appreciate that the thickness of individual layers for multilayer films may be adjusted based on desired end-use performance, resin or copolymer employed, equipment capability, and other factors. The materials forming each layer may be coextruded through a coextrusion feedblock and die assembly to yield a film with two or more layers adhered together but differing in composition. Coextrusion can be adapted for use in both cast film or blown film processes. Exemplary multilayer films have at least two, at least three, or at least four layers. In one embodiment, the multilayer films are composed of five to ten layers.

To facilitate discussion of different film structures, the following notation is used herein. Each layer of a film is denoted “A” or “B”. Where a film includes more than one A layer or more than one B layer, one or more prime symbols (′, ″, ′″, etc.) are appended to the A or B symbol to indicate layers of the same type that can be the same or can differ in one or more properties, such as chemical composition, density, melt index, thickness, etc. Finally, the symbols for adjacent layers are separated by a slash (/). Using this notation, a three-layer film having an inner layer disposed between two outer layers would be denoted A/B/A′. Similarly, a five-layer film of alternating layers would be denoted A/B/A′/B′/A″. Unless otherwise indicated, the left-to-right or right-to-left order of layers does not matter, nor does the order of prime symbols; e.g., an A/B film is equivalent to a B/A film, and an A/A′/B/A″ film is equivalent to an A/B/A′/A″ film, for purposes described herein. The relative thickness of each film layer is similarly denoted, with the thickness of each layer relative to a total film thickness of 100 (dimensionless) indicated numerically and separated by slashes; e.g., the relative thickness of an A/B/A′ film having A and A′ layers of 10 μm each and a B layer of 30 μm is denoted as 20/60/20.

The thickness of each layer of the film, and of the overall film, is not particularly limited, but is determined according to the desired properties of the film. Typical film layers have a thickness of from about 1 to about 1,000 μm, more typically from about 5 to about 100 μm, and typical films have an overall thickness of from about 10 to about 100 μm.

In some embodiments, and using the nomenclature described above, the present invention provides for multilayer films with any of the following exemplary structures: (a) two-layer films, such as A/B and B/B′; (b) three-layer films, such as A/B/A′, A/A′/B, B/A/B′ and B/B′/B″; (c) four-layer films, such as A/A′/A″/B, A/A′/B/A″, A/A′/B/B′, A/B/A′/B′, A/B/B′/A′, B/A/A′/B′, A/B/B′/B″, B/A/B′/B″ and B/B′/B″/B′″; (d) five-layer films, such as A/A′/A″/A′″/B, A/A′/A″/B/A′″″, A/A′/B/A″/A′″″, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′/B″/B′″, B/A/B′/B″/B′″, B/B′/A/B″/B′″, and B/B′/B″/B′″/B″ ″; and similar structures for films having six, seven, eight, nine, twenty-four, forty-eight, sixty-four, one hundred, or any other number of layers. It should be appreciated that films having still more layers.

In any of the embodiments above, one or more A layers can be replaced with a substrate layer, such as glass, plastic, paper, metal, etc., or the entire film can be coated or laminated onto a substrate. Thus, although the discussion herein has focused on multilayer films, the films may also be used as coatings for substrates such as paper, metal, glass, plastic, and other materials capable of accepting a coating.

The films can further be embossed, or produced or processed according to other known film processes. The films can be tailored to specific applications by adjusting the thickness, materials and order of the various layers, as well as the additives in or modifiers applied to each layer.

### Test Methods

Gauge thickness of a film is determined during the MD tensile test (based on ASTM D882), which is one time measurement and is close to the targeted film gauge values.

Tensile properties, including yield strength, elongation at yield, tensile strength, and elongation at break, as well as 1% secant modulus are based on ASTM D882.

The DSC run setting are performed with PerkinElmer′ DSC 8000. Peak melting point or melting temperature (Tm), peak crystallization temperature or crystallization temperature (Tc) and heat of fusion or heat flow (ΔHf or Hf) are determined using the following DSC procedure. Samples weighing approximately 5 mg are carefully sealed in aluminum hermetic pan. Heat flow is normalized with the sample mass. The material is held at −20° C. for 5 min and then the material is ramped up from −20° C. at 10° C./min to 200° C., after equilibration (3 min at 200° C.), the samples are cooled down at 10° C./min to −20° C. and equilibrate for 5 min. After the cooling process where the Tc is determined, a second melting process wa is s performed to determine the Tm. Once again the material is heated from −20° C. at 10° C./min up to 200° C. The melting (Tm) and crystallization (Tc) peak temperatures are calculated by integrating the peak position over a temperature range which well-included the peak (baseline).

The small amplitude oscillatory shear (SAOS) measurements are made on the Ares-G2 Rheometer by TA Instruments. Samples are compression molded at 177° C. for 15 minutes (including cool down under pressure) and 25 mm testing disk specimen are die cut from the resulting plaques. Measurements are conducted using a 25 mm parallel plate geometry. Tests are run from 0.01 to 500 rad/s and carried out at T=190° C. under 5% strain. To quantify the shear-like rheological behavior, the degree of shear thinning (DST) parameter is defined. The DST is measured by the following expression: DST=η*(0.05 rad/s)−η*(50 rad/s)/η*(0.05 rad/s) where η*(0.05 rad/s) and η*(50 rad/s) are the complex viscosities at frequencies of 0.05 and 50 rad/s, respectively, measured at 190° C. The higher is the DST parameter, the higher is the degree of shear thinning. Also, tan (η) at η=0.05 rad/s is determined, which is the tangent of the phase angle: G″/G′, the ratio of viscous modulus (G″) to elastic modulus (G′) and the complex viscosity η* at 0.05 rad/s.

Gel Permeation Chromatography (GPC) is a liquid chromatography technique used to measure the molecular weight and polydispersity of polymers.

Unless otherwise indicated, the distribution and the moments of molecular weight (e.g., Mw, Mn, Mz, Mw/Mn) and the comonomer content (e.g., C2, C3, C6) is determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 mL/min, and the nominal injection volume is 200 μL. The whole system including transfer lines, columns, and detectors is contained in an oven maintained at 145° C. The polymer sample is weighed and sealed in a standard vial with 80-μL flow marker (heptane) added to it. After loading the vial in the autosampler, polymer is dissolved in the instrument with 8 mL added TCB solvent. The polymer is dissolved at 160° C. with continuous shaking for about 1 hour for polyethylene samples or about 2 hours for polypropylene samples. The TCB densities used in concentration calculation is 1.463 g/ml at room temperature and 1.284 g/mL at 145° C. The sample solution concentration is from 0.2 to 2.0 mg/mL, with lower concentrations being used for higher molecular weight samples. The concentration (c), at each point in the chromatogram is calculated from the baseline-subtracted IR5 broadband signal intensity (I), using the following equation: c=βI, where β is the mass constant. The mass recovery can be calculated from the ratio of the integrated area of the concentration chromatography over elution volume and the injection mass, which is equal to the pre-determined concentration multiplied by injection loop volume.

Conventional molecular weight (IR molecular weight): determined by combining universal calibration relationship with the column calibration, which is performed with a series of monodispersed polystyrene (PS) standards ranging from 700 to 10,000,000 gm/mole. The molecular weight at each elution volume is calculated with (1):

$$log M = \frac{log ( {K}_{PS} / K )}{a + 1} + \frac{{a}_{PS} + 1}{a + 1} log {M}_{PS} \qquad EQ . 1$$

where the variables with subscript “PS” stand for polystyrene while those without a subscript are for the test samples. In this method, αPS=0.67 and KPS=0.000175 while α and K for other materials are as calculated and published in literature (Sun, T. et al. Macromolecules 2001, 34, 6812), except that for purposes of this invention and claims thereto, α=0.705 and K 30=0.0002288 for linear propylene polymers, α=0.695 and K=0.000181 for linear butene polymers, α is 0.695 and K is 0.000579*(1-0.0087*w2b+0.000018*(w2b)\hat{ }2) for ethylene-butene copolymer where w2b is a bulk weight percent of butene comonomer, α is 0.695 and K is 0.000579*(1−0.0075*w2b) for ethylene-hexene copolymer where w2b is a bulk weight percent of hexene comonomer, and α is 0.695 and K is 0.000579*(1-0.0077*w2b) for ethylene-octene copolymer where w2b is a bulk weight percent of octene comonomer, and α=0.695 and K=0.000579 for all other linear ethylene polymers. Concentrations are expressed in g/cm3, molecular weight is expressed in g/mole, and intrinsic viscosity (hence K in the 5 Mark-Houwink equation) is expressed in dL/g, unless otherwise noted.

Comonomer composition: determined by the ratio of the IR5 detector intensity corresponding to CH₂ and CH₃ channel calibrated with a series of polyethylene and propylene homo/copolymer standards whose nominal value are predetermined by NMR or FTIR. In particular, this provides the methyls per 1000 total carbons (CH₃/1000TC) as a function of molecular weight. The short-chain branch (SCB) content per 1000TC (SCB/1000TC) can be then computed as a function of molecular weight by applying a chain-end correction to the CH₃/1000TC function, assuming each chain to be linear and terminated by a methyl group at each end. The weight % comonomer can be then obtained from the following expression in which f is 0.3, 0.4, 0.6, 0.8, and so on for C3, C4, C6, C8, and so on co-monomers, respectively:

$$w 2 = f * SCB / 1000 TC \qquad EQ . 2$$

The bulk composition of the polymer from the GPC-IR and GPC-4D analyses is obtained by considering the entire signals of the CH3 and CH2 channels between the integration limits of the concentration chromatogram. First, the following ratio is obtained.

$$Bulk IR ratio = \frac{Area of {CH}_{3} signal within integration limits}{Area of {CH}_{2} signal within integration limits} \qquad EQ . 3$$

Then the same calibration of the CH3 and CH2 signal ratio, as mentioned previously in obtaining the CH3/1000TC as a function of molecular weight, is applied to obtain the bulk CH3/1000TC. A bulk methyl chain ends per 1000TC (bulk CH3end/1000TC) is obtained by weight-averaging the chain-end correction over the molecular-weight range. Then:

$$w 2 b = f * bulk CH 3 / 1000 TC \qquad EQ . 4$$

$$bulk SCB / 1000 TC = bulk CH 3 / 1000 TC - bulk CH 3 end / 1000 TC \qquad EQ . 5$$

Lastly, bulk SCB/1000TC are converted to bulk w2 in the same manner as described above.

LS molecular weight: The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972):

$$\frac{{K}_{o} c}{Δ R ( θ )} = \frac{1}{MP ( θ )} + 2 {A}_{2} c \qquad EQ . 6$$

Here, ΔR(θ) is the measured excess Rayleigh scattering intensity at scattering angle θ, c is the polymer concentration determined from the IR5 analysis, A2 is the second virial coefficient, P(θ) is the form factor for a monodisperse random coil, and K_{O} is the optical constant for the system:

$${K}_{O} = \frac{4 {π}^{2} {{n}^{2} ( dn / dc )}^{2}}{{λ}^{4} {N}_{A}} {K}_{O} = \frac{4 {π}^{2} {{n}^{2} ( dn / dc )}^{2}}{{λ}^{4} {N}_{A}} \qquad EQ . 7$$

where NA is Avogadro's number, and (dn/dc) is the refractive index increment for the system, n=1.500 for TCB at 145° C., and λ=665 nm. For analyzing ethylene homopolymers, ethylene-hexene copolymers, and ethylene-octene copolymers, dn/dc=0.1048 ml/mg and A2=0.0015; for analyzing ethylene-butene copolymers, dn/dc=0.1048*(1-0.00126*w2) ml/mg and A2=0.0015 where w2 is weight percent butene comonomer, for all other ethylene polymers dn/dc=0.1048 ml/mg and A2=0.0015.

Viscosity MW: A high temperature viscometer, such as those made by Technologies, Inc. or Viscotek Corporation, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηs, for the solution flowing through the viscometer is calculated from their outputs. The intrinsic viscosity, [η], at each point in the chromatogram is calculated from the equation [η]=ηs/c, where c is concentration and is determined from the IR5 broadband channel output. The viscosity MW at each point is calculated as M=K_{PS}M^{α}^{_{PS}}⁺¹/[η], where aps is 0.67 and Kps is 0.000175. The average intrinsic viscosity, <[η]> of the sample is calculated by:

$$〈 [ η ] 〉 = \frac{\sum {{c}_{i} [ η ]}_{i}}{\sum {c}_{i}} \qquad EQ . 8$$

where the summations are over the chromatographic slices, i, between the integration limits.

The long chain branching index (g′LCB, also referred to as g′vis) is defined as

$${g}_{LCB}^{′} = \frac{〈 [ η ] 〉}{K {〈 {M}_{IR} 〉}^{α}} \qquad EQ . 9$$

where [symbol] (M_{IR} [symbol] is the viscosity average molecular weight calibrated with polystyrene standards, K and α are for the reference linear polymer, which are as calculated and published in literature (Sun, T. et al. Macromolecules 2001, 34, 6812), except that for purposes of this invention and claims thereto, α=0.705 and K=0.0002288 for linear propylene polymers, α=0.695 and K=0.000181 for linear butene polymers, α is 0.695 and K is 0.000579*(1-0.0087*w2b+0.000018*(w2b)\hat{ }2) for ethylene-butene copolymer where w2b is a bulk weight percent of butene comonomer, α is 0.695 and K is 0.000579*(1-0.0075*w2b) for ethylene-hexene copolymer where w2b is a bulk weight percent of hexene comonomer, and α is 0.695 and K is 0.000579*(1-0.0077*w2b) for ethylene-octene copolymer where w2b is a bulk weight percent of octene comonomer, and α=0.695 and K=0.0005 for all other linear ethylene polymers.

Either the IR or LS detectors as noted above can be used for obtaining molecular weight values from GPC. The LS detector is used for molecular weight values noted herein, unless specifically noted otherwise as coming from the IR detector. However, we have also specifically noted in many instances the LS detector's use for molecular weight values—for example, a weight-average molecular weight determined using LS detector may be denoted as Mw (LS). Furthermore, all comonomer wt % s as determined at specific molecular weight values (e.g., comonomer wt % at Mw, and/or at Mn, and/or at Mz) are determined based upon the molecular weight value as determined using LS detectors. Otherwise, where one sees Mz (IR), Mw (IR), etc., then the IR detector is used.

The wt % C6 Mz is determined by selecting the comonomer value at the Mz value on the GPC-4D trace produced by the GPC method described above. The Mz value is obtained from the LS detector. For example, if the Mz-LS is 300,000 g/mol, the value on the comonomer on the GPC-4D graph at 300,000 g/mol is used. The wt % C6 Mw is determined by selecting the comonomer value at the Mw value on the GPC-4D trace. The Mw value is obtained from the LS detector. For example, if the Mw-LS is 100,000 g/mol, the value on the comonomer on the GPC-4D graph at 100,000 g/mol is used. The wt % C6 Mn is determined by selecting the comonomer value at the Mn value on the GPC-4D trace. For example, if the Mn-LS is 15,000 g/mol, the comonomer value on the GPC-4D graph at 15,000 g/mol is used.

Needle puncture tests are measured by CEN 14477.

### EXAMPLES

To facilitate a better understanding of the embodiments of the present invention, the following examples of preferred or representative embodiments are given. In no way should the following examples be read to limit, or to define, the scope of the invention.

### Example 1

A polyethylene composition (the inventive resin (I-1)) having a surprising balance between a BOCD-type profile and molecular weight was prepared using the process and catalyst described in the examples of WO2019/083609A1. Table 1 below reports the resin properties of the inventive example I-1 as well as two other commercially available LDPEs (Control 1 (C-1) and Control 2 (C-2)). The comparative Control 1 (C-1) was Exceed 2018HA, and Control 2 (C-2) was Exceed XP 8656ML, both are commercially available from ExxonMobil Chemical Company.

TABLE 1
Resin Properties

| Property | C-1 | C-2 | I-1 |
|---|---|---|---|
| Melt index, I_{2.16} (g/10 min) | 1.94 | 0.52 | 1.68 |
| High loading melt index, I21.6 (g/10 min) | 30.31 | 15.66 | 55.55 |
| Melt index ratio (I_{21.6}/I_{2.16}) (—) | 15.62 | 30.12 | 33.07 |
| Density, ρ (g/cm³) | 0.919 | 0.917 | 0.924 |
| Melting temperature, Tₘ₂ (° C.) | 116.86 | 119.7 | 123.23 |
| Crystallization temperature, Tc1 (° C.) | 103.87 | 106.21 | 110.74 |
| Number average molecular weight, Mn (g/mol) (IR) | 27,149 | 28,680 | 14,706 |
| Weight average molecular weight, Mw (g/mol) (IR) | 94,388 | 141,775 | 97,255 |
| Z-average molecular weight, Mz (g/mol) (IR) | 169,845 | 366,553 | 259,736 |
| Z + 1 average molecular weight, Mz + 1 (g/mol) (IR) | 265,285 | 655,190 | 470,301 |
| Comonomer content, C6 (wt %) | 7.55 | 9.19 | 8.45 |
| Mw/Mn Ratio (IR) | 3.48 | 4.94 | 6.61 |
| Mz/Mw Ratio (IR) | 1.80 | 2.59 | 2.67 |
| Mz/Mn Ratio (IR) | 6.26 | 12.78 | 17.66 |
| Number average molecular weight, Mn (g/mol) (LS) | 28,308 | 28,952 | 14,738 |
| Weight average molecular weight, Mw (g/mol) (LS) | 96,289 | 146,815 | 106,914 |
| Z-average molecular weight, Mz (g/mol) (LS) | 169,817 | 366,480 | 286,773 |
| Mw/Mn Ratio (LS) | 3.40 | 5.07 | 7.25 |
| Mz/Mw Ratio (LS) | 1.76 | 2.50 | 2.68 |
| Mz/Mn Ratio (LS) | 6.00 | 12.66 | 19.46 |
| wt % comonomer at Mz (LS)/wt % comonomer at Mw | 1.05 | 1.28 | 1.35 |
| (LS) Ratio | | | |
| wt % comonomer at Mn (LS)/wt % comonomer at Mw | 0.93 | 0.41 | 0.22 |
| (LS) Ratio | | | |
| wt % comonomer at Mz (LS)/wt % comonomer at Mn | 1.12 | 3.09 | 4.56 |
| (LS) Ratio | | | |
| Tan(δ) at ω = 0.05 rad/s (—) | 98.92 | 19.94 | 37.26 |
| Complex viscosity, η* at ω = 0.05 rad/s (Pa · s) | 3891 | 17832 | 5345 |
| Degree of Shear Thinning, DST (—) | 0.40 | 0.80 | 0.67 |

FIG. 1 graphically depicts the GPC4D Data of C-1, C-2 and I-1. As shown, C-2 and the inventive resin I-1 are BOCD. Resin C-1 is not BOCD, despite the C-1 resin having a similar Mw as the inventive resin I-1.

### Example 2

The resins were made into films. The precursor of the MDO films was produced on an Alpine monolayer film line where the film gauge was about 120 μm, the blow-up ratio (BUR) was 2.5, the line output was 120 kg/h and the frost line height (FLH) was 550 mm. In addition, the screw diameter was 65 mm and the L/D ratio was about 30, the die diameter was 160 mm and finally the die gap was 1.5 mm.

The blown films were then loaded on a winder of the MDO equipment with an unwinding speed of 5 m/min. The speed was maintained till the preheating region afterwards was increased in the stretching region, depending on the final orientation. MDO films were made in the 3×-10× range. The speed was between 15m/min to 50 m/min, respectively. The temperature profile of the rollers is reported in Table 2. The resulting film properties are reported in Table 3.

TABLE 2
Film Processing

| | Preheating | | | Stretching | | Annealing | | | Cooling | | | | | | |
|---|---|---|---|---|---|---|---|---|---|---|---|---|---|---|---|
| Roller | V01 | V02 | V03 | V1 | V2 | V3 | V3.5 | V4 | V5.1/V5.2 | V6.1/V6.2 | V7 | V8 | V9 | V10 | V11 |
| Condition 1: | 80 | 90 | 103 | 110 | 110 | 105 | 108 | 95 | 90 | 80 | 75 | 65 | 50 | 40 | 25 |
| Orientation range | | | | | | | | | | | | | | | |
| 3x-8x; | | | | | | | | | | | | | | | |
| Temperature [° C.] | | | | | | | | | | | | | | | |
| Condition 2: | 80 | 95 | 108 | 115 | 111 | 110 | 108 | 95 | 90 | 80 | 75 | 65 | 50 | 40 | 25 |
| Orientation range | | | | | | | | | | | | | | | |
| 9x-10x; | | | | | | | | | | | | | | | |
| Temperature [° C.] | | | | | | | | | | | | | | | |

TABLE 3a
Film Properties

| | | 3x | 4x | 5x | 6x | 7x | 3x | 4x | 5x | 6x | 8x |
|---|---|---|---|---|---|---|---|---|---|---|---|
| Film Property | Methods | C-1 | C-1 | C-1 | C-1 | C-1 | C-2 | C-2 | C-2 | C-2 | C-2 |
| Gauge MD (μm)* | ASTM | 40 | 31 | 26 | 21 | 17 | 41 | 32 | 24 | 20 | 15 |
| 1% secant modulus (MPa) MD | D882 | 297 | 344 | 369 | 505 | 606 | 261 | 303 | 402 | 460 | 531 |
| Elongation at break (%) MD | | 301 | 219 | 158 | 87 | 72 | 146 | 115 | 72 | 55 | 75 |
| Tensile at break (MPa) MD | | 88.5 | 103.3 | 113.8 | 131.4 | 204.4 | 96.8 | 133.3 | 180.5 | 190.2 | 119.9 |
| 1% secant modulus (MPa) TD | | 505 | 588 | 645 | 711 | 767 | 479 | 517 | 594 | 569 | 485 |
| Elongation at break (%) TD | | 849 | 897 | 910 | 987 | 1,008 | 749 | 795 | 863 | 856 | 581 |
| Tensile at break (MPa) TD | | 40.5 | 40.9 | 35.1 | 36.6 | 31.1 | 52.7 | 49.2 | 47.2 | 37.2 | 24.7 |
| Energy to break normalized, | CEN | 0.22 | 0.23 | 0.26 | 0.34 | 0.4 | 0.3 | 0.28 | 0.32 | 0.31 | 0.22 |
| puncture (mJ/mm) | 14477 | | | | | | | | | | |
| Peak force normalized, | | 81.85 | 90.14 | 102.82 | 133.54 | 171.04 | 109.92 | 123.62 | 156.15 | 165.06 | 116.61 |
| puncture (mN/mm) | | | | | | | | | | | |

TABLE 3b
Film Properties

| | | 4x | 5x | 6x | 7x | 8x | 9x | 10x |
|---|---|---|---|---|---|---|---|---|
| Film Property | Methods | I-1 | I-1 | I-1 | I-1 | I-1 | I-1 | I-1 |
| Gauge MD (μm)* | ASTM | 31 | 25 | 20 | 18 | 15 | 15 | 13 |
| 1% secant modulus (MPa) MD | D882 | 390 | 374 | 628 | 776 | 1,036 | 913 | 1,053 |
| Elongation at break (%) MD | | 152 | 103 | 68 | 48 | 18 | 31 | 24 |
| Tensile at break (MPa) MD | | 135 | 155.3 | 192.9 | 213.6 | 209.8 | 189.6 | 207.3 |
| 1% secant modulus (MPa) TD | | 706 | 712 | 770 | 766 | 834 | 729 | 789 |
| Elongation at break (%) TD | | 834 | 850 | 881 | 868 | 909 | 943 | 950 |
| Tensile at break (MPa) TD | | 41.4 | 38.4 | 37.6 | 33.3 | 32.2 | 32.7 | 30.3 |
| Energy to break normalized, | CEN | 0.16 | 0.20 | 0.22 | 0.25 | 0.28 | 0.28 | 0.31 |
| puncture (mJ/mm) | 14477 | | | | | | | |
| Peak force normalized, | | 92.05 | 112.39 | 133.81 | 161.02 | 201.29 | 176.04 | 195.17 |
| puncture (mN/mm) | | | | | | | | |

FIG. 2 shows the 100 secant modulus vs. MDO of resins C-1, C-2 and I-1. The stiffness, as measured by 1% secant modulus, of the inventive resin (I-1) increased up to 8× and then plateaued at higher orientations. More notably, the 10% secant modulus values of the inventive resin (I-1) were higher than those of the comparative resins C-1, C-2 and was maintained at higher orientations above 8×.

FIG. 3 shows the peak force (puncture) vs. MDO of resins C-1, C-2 and I-1. As depicted, the inventive resin (I-1) reached outstanding values as the orientation increased and the peak force values were maintained up to 10×. In comparison, the peak force of the comparative resins C-1 and C-2 decreased significantly at orientations above 7×.

In summary, the inventive resin (I-1) provided MDO films having a surprising and unexpected balance of high stiffness and toughness while maintaining high orientability (processability) superior to the two comparative resins, i.e. Exceed™ 2018HA (C-1) and Exceed XP™ 8656ML (C-2). In addition, the inventive resin was oriented up to 10× by adjusting the temperature profile, which was not obtained with the two comparative resins (i.e. the film controls at higher roll temperatures strongly adhered at the roll surface and at lower temperatures were stretched inhomogeneously). The higher orientations provided significantly downgauged films without drastically impacting the mechanical properties. In fact, the films maintained excellent stiffness (e.g. 1% secant modulus) and toughness (e.g. needle puncture, where the C-2 puncture force drops after 8×) at the higher orientations. This was nothing short of surprising and unexpected.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

While the present disclosure has been described with respect to a number of embodiments and examples, those skilled in the art, having the benefit of this disclosure, will appreciate that other embodiments can be devised which do not depart from the scope and spirit of the present disclosure.

1. A polyethylene composition comprising:
about 80 wt % to about 99 wt % ethylene-derived content, and about 1.0 wt % to about 20 wt % units derived from one or more C₃ to C₄₀ α-olefin comonomers, based on a total weight of the polyethylene composition, wherein the polyethylene composition comprises:
a density of 0.922 g/cm³ to 0.940 g/cm³;
a melt index (I_{2.16}) of 0.1 g/10 min to 5 g/10 min;
a melt index ratio (I_{2.16}/I_{21.6}) of 10 to 50;
a weight average molecular weight, Mw (LS) of 90,000 g/mol or above;
a molecular weight distribution (Mw/Mn) ratio (LS) of 5.5 or above;
a ratio of z-average molecular weight to weight-average molecular weight (Mz/Mw) of 2 to 5;
a ratio of wt % comonomer at Mz (LS) to wt % comonomer at Mw (LS) of I to 5;
a ratio of wt % comonomer at Mn (LS) to wt % comonomer at Mw (LS) of 0.1 to 0.9; and
a ratio of wt % comonomer at Mz (LS) to wt % comonomer at Mn (LS) of 2 to 10.

2. The polyethylene composition of claim 1, wherein the C₃ to C₄₀ α-olefin comonomers is selected from the group consisting of 1-butene; 1-hexene, 1-octene, and combinations thereof.

3. The polyethylene composition of claim 1, wherein the comonomer content is 6 wt % to 12 wt %.

4. The polyethylene composition of claim 1, wherein the comonomer content is 7-10 wt % and the comonomer is 1-hexene.

5. The polyethylene composition of claim 1, further comprising:
z-average molecular weight (Mz) (LS) within the range from 200,000 g/mol to 500,000 g/mol;
weight-average molecular weight (Mw) (LS) within the range from 50,000 g/mol to 110,000 g/mol;
$$Mz / Mw ratio ( LS ) of 2 to 5 ; and$$
$$Mw / Mn of 4 to 8.$$

6. The polyethylene composition of claim 1, wherein the melt index ratio (MIR, I_{21.6}/I_{2.16}) is 15 to 40 and ratio of MIR/(Mz/Mw) is less than 10.

7. The polyethylene composition of claim 1, wherein the melt index I_{2.16} is from 0.4 g/10 min to 2.0 g/10 min.

8. An oriented polyethylene film, comprising:
a polyethylene composition of claim 1, wherein the film has a 1% secant modulus (MPa) MD of 500 to 1,500; Tensile at break (MPa) MD of 100 to 300; and Peak force normalized, puncture (mN/mm) of 100 to 300 with a gauge thickness of 50 mils or less.

9. The film of claim 8, wherein the film has a gauge thickness of 40 mils or less.

10. The film of claim 8, wherein the film has a gauge thickness of 35 mils or less.

11. The film of claim 8, wherein the film has a gauge thickness of 15 mils or less.

12. The film of claim 8, wherein the film has at least an 8× orientation.

13. The film of claim 12, wherein the film has at least a 10× orientation.

14. The film of claim 8, wherein the film has one or more of the following properties:
(a) tan(δ) at ω=0.05 rad/s of 10 to 80;
(b) Complex viscosity, η* at ω=0.05 rad/s (Pa s) of 2,000 to 20,000;
(c) Degree of Shear Thinning, DST of 0.4 to 0.9;
(d) 1% secant modulus (MPa) MD of 500 to 1,500;
(e) 1% secant modulus (MPa) TD of 400 to 1,000;
(f) Tensile at break (MPa) MD of 100 to 300;
(g) Tensile at break (MPa) TD of 20 to 50; and
(h) Peak force normalized, puncture (mN/mm) of 100 to 300.

15. The method for making a film, comprising:
producing a polymer melt comprising a polyethylene composition of claim 1;
extruding a film from the polymer melt; and
orienting the film in a machine direction at a temperature below the melting temperature of the polyethylene composition, where the film has a gauge thickness less than 15 mils, a 1% secant modulus (MPa) MD of 500 to 1,500; Tensile at break (MPa) MD of 100 to 300; and Peak force normalized, puncture (mN/mm) of 100 to 300.

16. The method of claim 15, wherein the 1% secant modulus (MPa) MD is 500 to 1,000; Tensile at break (MPa) MD is 100 to 200; and Peak force normalized, puncture (mN/mm) is 100 to 200.

17. The method of claim 15, wherein the orientation in the machine direction is at least 8×.

18. The method of claim 17, wherein the orientation in the machine direction is at least 10×.
